(19) United States
(12) Patent Application Publication
(10) Pub. No.: US 2025/0173938 A1
(43) Pub. Date: May 29, 2025

(54) EXPRESSING EMOTION IN SPEECH FOR CONVERSATIONAL AI SYSTEMS AND APPLICATIONS

(71) Applicant: NVIDIA Corporation, Santa Clara, CA (US)

(72) Inventors: Ehsan Hosseini Asl, Boston, MA (US); Nikhil Srihari, Seattle, WA (US); Oluwatobi Olabiyi, Falls Church, VA (US); Akshay Hazare, Mumbai (IN)

(21) Appl. No.: 18/521,310

(22) Filed: Nov. 28, 2023

(51) Int. Cl. G06T 13/40; G06T 13/20

(52) U.S. Cl. CPC G06T 13/40; G06T 13/205

(57) ABSTRACT

In various examples, expressing emotion in speech for conversational AI systems and applications is described. Systems and methods are disclosed that use a machine learning model(s) (e.g., one or more large language models (LLMs)) to determine both an emotional state associated with speech output by a character and one or more values for one or more variables associated with the emotional state and/or the speech. For example, the variable(s) may include an intensity of the emotional state and/or a pitch, a rate, a volume, an emphasis, and/or the like of the speech. In some examples, the machine learning model(s) may determine the emotional state and/or the value(s) of the variable(s) using various types of inputs in addition to the text of the speech, such as user data and/or character data. The character may then output the speech in a way that expresses the emotional state.

### BACKGROUND

Many applications, such as gaming applications, interactive applications, communications applications, multimedia applications, videoconferencing applications, in-vehicle infotainment applications, and/or the like, use animated characters or digital avatars that interact with users of the applications/machines/devices and/or interact with other animated characters within the applications (e.g., non-player characters (NPCs)). In order to provide more realistic experiences for users, systems may attempt to animate characters by expressing emotion when interacting with users. For example, when determining speech that an animated character is to output to a user, a system may also determine an emotional state associated with the animated character, such as based on an analysis of the text of the speech. The emotional state may then be used such that the animated character outputs the speech in a way that expresses the emotional state. For example, the voice of the animated character that is used to output the speech may reflect the emotional state of the animated character.

However, by only using the text of the speech to determine emotional states, the systems may incorrectly determine the emotional states based on the circumstances of the interactions. For example, people may express the same text, such as “Have a good day,” using different emotional states, such as happy or sad. As such, by merely associating text with an emotional state that is then later used by animated characters when outputting speech corresponding to the text, the animated characters may express their speech using an improper or inaccurate emotional state that may result in an undesired user experience. Additionally, by only using set emotional states for animated characters, such as happy or sad, the systems may be unable to cause the animated characters to express a wide range or spectrum of emotional states with speech. For example, people may express the same emotional state differently at different times, such as if a person is somewhat happy or very happy. When expressing the same emotional state differently, the user speech may also change, such as the characteristics (e.g., pitch, rate, etc.) of the user speech.

### SUMMARY

Embodiments of the present disclosure relate to expressing emotion in speech for conversational AI systems and applications. Systems and methods are disclosed that use one or more machine learning models to determine both an emotional state associated with speech being output by a character and one or more values for one or more variables associated with the emotional state and/or the speech. For example, the variable(s) may include an intensity of the emotional state and/or a pitch, a rate, a volume, a tone, an emphasis, and/or other attributes of the speech. In some examples, the machine learning model(s) may determine the emotional state and/or the value(s) of the variable(s) using various types of inputs in addition to the text of the speech, such as user data representing information associated with a user and/or character data representing information associated with the character. The systems and methods may then cause the character to output the speech in a way that expresses the emotional state based at least on the value(s).

In contrast to conventional systems, the present systems and methods, in embodiments, are able to determine emotional states associated with speech using additional inputs in concert with the text of the speech. As described in more detail herein, by using the additional inputs, the current systems may then better determine the actual emotional states of the speech—e.g., because the same text may be associated with different emotional states based on other circumstances associated with the speech. Additionally, in contrast to the conventional systems, the current systems, in some embodiments, are able to determine additional values for variables associated with the emotional states and/or the speech. As described in more detail herein, by determining the additional values associated with the variables, the current systems are able to animate characters such that the characters better express the emotional states within the speech.

### BRIEF DESCRIPTION OF THE DRAWINGS

The present systems and methods for expressing emotion in speech for conversational AI systems and applications are described in detail below with reference to the attached drawing figures, wherein:

FIG. 1A illustrates a first example data flow diagram of a first process of using one or more machine learning models to generate speech that expresses emotional states, in accordance with some embodiments of the present disclosure;

FIG. 1B illustrates a second example data flow diagram of a second process of using one or more machine learning models to generate speech that expresses emotional states, in accordance with some embodiments of the present disclosure;

FIG. 2 illustrates an example of generating text associated with a user input, in accordance with some embodiments of the present disclosure;

FIG. 3 illustrates an example of determining emotions information associated with speech that is output by a character, in accordance with some embodiments of the present disclosure;

FIG. 4 illustrates an example of generating speech that expresses emotion, in accordance with some embodiments of the present disclosure;

FIG. 5 illustrates an example of determining both text and emotional information associated with speech that is output by a character, in accordance with some embodiments of the present disclosure;

FIG. 6 illustrates a data flow diagram illustrating a process for training one or more models to generate emotion information associated with speech, in accordance with some embodiments of the present disclosure;

FIG. 7 illustrates a flow diagram showing a method for causing a character to communicate using speech that expresses emotion, in accordance with some embodiments of the present disclosure;

FIG. 8 illustrates a flow diagram showing a method for generating audio data representing speech that expresses emotion, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to expressing emotion in speech for conversational AI systems and applications. For instance, a system(s) may receive input data associated with at least one of a user or a character that is being animated. For example, and for the user, the input data may include text data representing text input by the user (or converted from audio), audio data representing speech from the user (e.g., in the form of a spectrogram), image data representing images depicting the user, profile data representing information about the user, and/or any other type of data. As described herein, text may represent one or more letters, words, symbols, numbers, characters, punctuation marks, tokens, and/or the like. Additionally, and for the character, the input data may represent characteristics associated with the character (e.g., profession, relationships, personality traits, etc.), past communications, current circumstances (e.g., current interactions with other characters, current location, current objectives, etc.), and/or any other information associated with the character. While these examples describe the input data as being associated with the user and/or the character, in other examples, the input data may include any other type of input data (e.g., prompts, which is described in more detail herein).

The system(s) may then process the input data using one or more machine learning models (referred to, in some examples, as a “first machine learning model(s)”) associated with generating text. For instance, the first machine learning model(s) may be trained to process the input data and, based at least on the processing, generate the text associated with the speech that is to be output by the character. For a first example, if the input data represents inputted text and/or user speech that is associated with a query, then the text generated by the first machine learning model(s) may be associated with a response to the query. For a second example, if the input data represents character information, such as the current circumstances associated with the character (e.g., who the character is interacting with), then the text generated by the first machine learning model(s) may be related to the current circumstances.

The system(s) may also process the input data and/or text data representing the text using one or more machine learning models (referred to, in some examples, as a “second machine learning model(s)”) associated with determining emotions information, such as an emotional state. As described herein, an emotional state may include, but is not limited to, anger, calm, disgust, fearful, happy, helpful, humorous, sad, and/or any other emotional state. In some examples, the second machine learning model(s) may be the same as the first machine learning model(s). For instance, the system(s) may process the input data using the machine learning model(s) that is trained to both determine the text associated with the speech and determine the emotions information associated with the speech. In some examples, the second machine learning model(s) may be different than the first machine learning model(s). For instance, the system(s) may apply the input data and the text data generated using the first machine learning model(s) to the second machine learning model(s).

As described herein, the second machine learning model(s) may be trained to determine both the emotional state associated with the character along with one or more values for one or more variables associated with the emotional state and/or the speech (e.g., additional emotions information). For a first example, if the variable(s) is associated with an intensity of the emotional state, then a value may indicate very low, low, medium, high, very high, and/or any other intensity level. For a second example, the variable(s) associated with the speech may include, but is not limited to, a volume, a pitch, a resonance, a clarity, a rate, an emphasis, and/or any other characteristic or attribute associated with speech. As such, a value for volume may indicate silent, extra low, low, medium, high, extra high, and/or the like. Additionally, a value associated with pitch and/or rate may indicate extra low, low, medium, high, extra high, and/or the like.

The system(s) may then apply the text data representing the text and/or data (referred to, in some examples, as “emotions data”) representing the emotions information (e.g., the emotional state and/or the value(s) of the variable(s)) into one or more machine learning models (referred to, in some examples, as a “third machine learning model(s)”) associated with generating speech. For example, the third machine learning model(s) may include a text-to-speech model that is trained to generate audio data representing the speech. As described herein, the third machine learning model(s) may further be trained to generate the audio data such that the speech expresses the emotional state. For a first example, the speech represented by the audio data may be expressed based at least on the intensity of the emotional state. For a second example, the speech represented by the audio data may be associated with the value(s) of the characteristic(s) associated with the speech such that the speech is generated using the volume level, the pitch level, the rate level, any identified emphasis, and/or the like.

The system(s) may then cause the character to output the speech using at least the audio data. As such, by performing one or more of the processes described herein, the speech output by the character may better express the emotional state associated with the character. In some examples, the system(s) may then continue to perform these processes as the character continues to communicate with the user and/or one or more other characters. For example, the system(s) may continue to perform these processes in order to update the emotional state of the character for each letter, symbol, number, punctuation mark, word, sentence, paragraph, and/or the like associated with the speech that is output by the character.

The system(s) may use one or more techniques to train the second machine learning model(s) (and/or the combined first machine learning model(s) and second machine learning model(s)) to generate the emotions information that is then used to express emotion in speech. For example, the system(s) may train the second machine learning model(s) using prompt-tuning, prompt engineering, and/or any other training technique. As described herein, during the training, the second machine learning model(s) may be trained to both determine the emotional state associated with speech as well as determine the value(s) of the variable(s) associated with the emotional state and/or the speech. For example, the second machine learning model(s) may be trained using input data along with corresponding ground truth data representing emotional states and/or values for variables. Techniques for training one or more of the machine learning model(s) are described in more detail herein.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

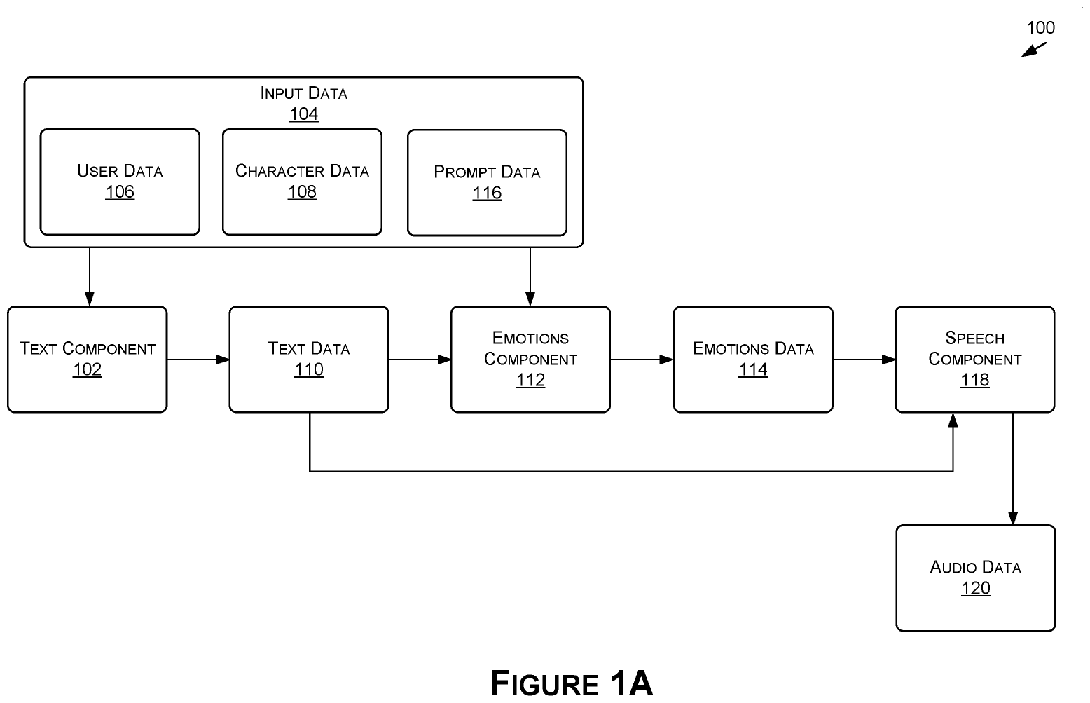

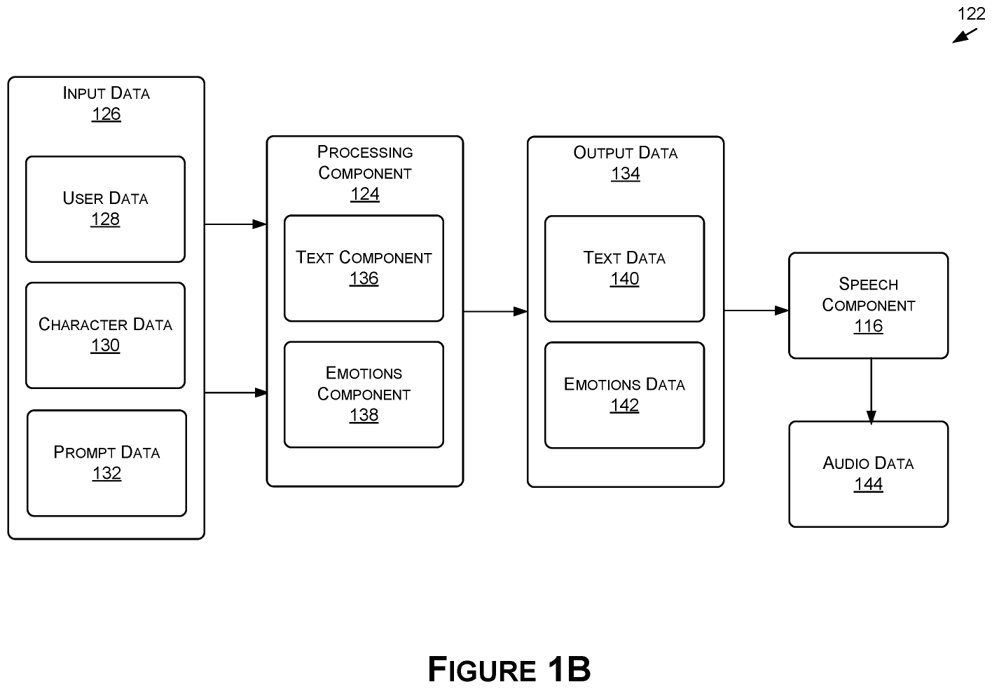

With reference to FIG. 1A, FIG. 1A illustrates a first example data flow diagram of a first process 100 of using one or more machine learning models to generate speech that expresses emotional states, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown, the process 100 may include a text component 102 receiving input data 104. As shown, the input data 104 may include user data 106, character data 108, and/or any other type of data that may be applied to the text component 102. As described herein, the user data 106 may include, but is not limited to, text data representing text input by one or more users (and/or text data generated from speech, such as via one or more translation, automatic speech recognition (ASR), diarization, and/or other speech-to-text (STT) processing models or algorithms), audio data representing user speech from the user(s), image data representing one or more images (e.g., a video) depicting the user(s) and/or an environment of the user(s), profile data representing information (e.g., locations, ages, interests, personality traits, etc.) associated with the user(s), emotions data representing one or more emotions associated with the user(s), and/or any other type of data that represents information associated with the user(s). In some examples, the text component 102 may receive the user data 106 based at least on the user(s) providing consent. For example, the user(s) may use one or more user devices in order to provide the information represented by the user data 106.

The character data 108 may represent information associated with the character that is to output speech. As described herein, the information may include, but is not limited to, characteristics associated with the character (e.g., profession, relationships, personality traits, etc.), past communications (e.g., past speech output by the character, etc.), current circumstances (e.g., current interactions with other characters, current location, current objectives, etc.), and/or any other information associated with the character. For a first example, the character data 108 may represent at least the current circumstances associated with the character, such as other characters the character is communicating with, whether the character is friendly or not friendly with the other characters, the location of the characters, and/or so forth. For a second example, the character data 108 may represent past text received, past text (or speech) output, past emotional states, and/or any other information associated with past communications associated with the character.

The process 100 may then include the text component 102 processing at least a portion of the input data 104 and, based at least on the processing, generating and/or outputting text data 110 representing text. As described herein, text may include, but is not limited to, one or more letters, words, symbols, numbers, characters, punctuation marks, tokens, and/or the like. In some examples, the text component 102 may include and/or use one or more machine learning models (e.g., one or more large language models), one or more neural networks, one or more algorithms, one or more tables, and/or any other service, tool, and/or technique to perform one or more of the processes described herein with respect to the text component 102. For example, the text component 102 may include one or more machine learning models that are trained to process the input data 104 in order to generate the text data 110, where the training is described in more detail herein.

In some examples, the text data 110 may be generated in a format that may be later processed by one or more other components and/or models. For example, the text data 110 may represent one or more tokens representing the text. In such an example, an individual token of the token(s) may represent a portion of the text, such as a letter, a word, a symbol, a number, a character, a punctuation mark, a token, and/or the like.

In some examples, the text data 110 may represent a response for the user(s). For example, if the user data 106 represents text associated with a comment, query, request, and/or the like, then the text represented by the text data 110 may include a response to the comment, query, request, and/or the like. In some examples, the text data 110 may represent text associated with the character communicating with one or more other characters. For example, if the character is communicating with the other character(s), then the text may include the words associated with the speech that the character is to output to the other character(s).

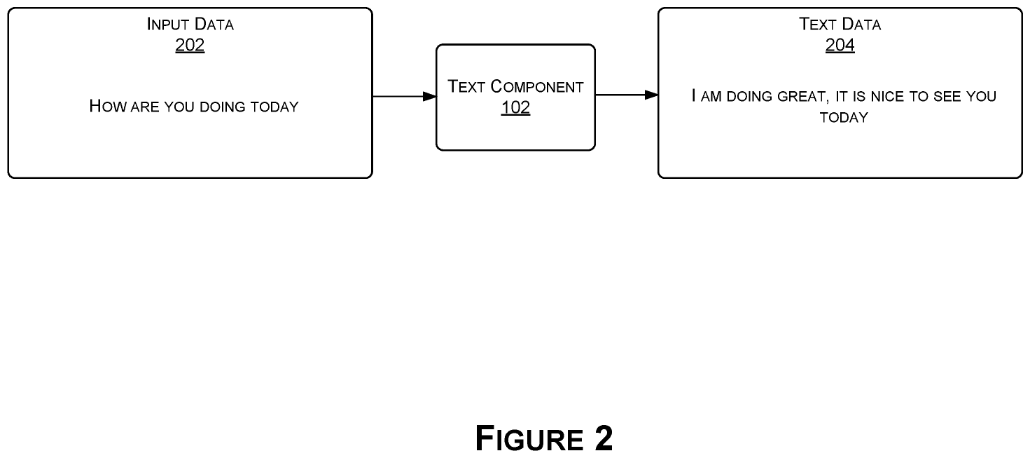

For instance, FIG. 2 illustrates an example of generating text associated with a user input, in accordance with some embodiments of the present disclosure. As shown by the example of FIG. 2, the text component 102 may receive input data 202 (which may represent, and/or include, the input data 104) that represents text input by a user (e.g., through speech, input devices, etc.), where the text includes the words “How are you doing today?” The text component 102 may then be configured to process the input data 202 (e.g., using one or more machine learning models) and, based at least on the processing, generate text data 204 representing additional text associated with a response. For instance, and as shown, the text may include the words “I am doing great, it is nice to see you.” While the example of FIG. 2 just illustrates the input data 202 as including the text, in other examples, the input data 202 may include any other type of input data described herein.

In the example of FIG. 2, the text data 204 may represent a series of tokens associated with the text. For example, the text data 204 may represent one or more first tokens for the word “I”, one or more second tokens for the word “am”, one or more third tokens for the “great”, and/or so forth. In other examples, the text may be tokenized in any suitable manner for processing using one or more machine learning models (e.g., LLMs). In some examples, the text component 102 may generate the text data 204 to represent the tokens such that additional components and/or models are able to process the text data 204.

Referring back to the example of FIG. 1A, the process 100 may include an emotions component 112 receiving at least a portion of the input data 104 and/or at least a portion of the text data 110. The process 100 may then include the emotions component 112 processing the at least a portion of the input data 104 and/or the at least a portion of the text data 110 and, based at least on the processing, generating, and/or outputting emotions data 114 associated with the text. In some examples, the emotions component 112 may include and/or use one or more machine learning models (e.g., one or more large language models), one or more neural networks, one or more algorithms, one or more tables, and/or any other service, tool, and/or technique to perform one or more of the processes described herein with respect to the emotions component 112. Additionally, the emotions data 114 may represent emotions information, such as at least an emotional state and one or more values for one or more variables associated with the emotional state and/or speech.

As described herein, an emotional state may include, but is not limited to, anger, calm, disgust, fearful, happy, helpful, humor, sad, and/or any other emotional state. Additionally, a variable associated with an emotional state may include at least an intensity of the emotional state. As such, a value may indicate an intensity level, such as very low, low, medium, high, very high, and/or any other intensity level associated with the emotional state. Furthermore, a variable associated with speech may include, but is not limited to, a volume, a pitch, a resonance, a clarity, a rate, an emphasis, and/or any other characteristic associated with speech. As such, a value associated with such a variable may indicate one or more levels and/or degrees associated with the variable. For a first example, a value for volume may include silent, extra low, low, medium, high, extra high, and/or the like. For a second example, a value associated with pitch and/or rate may include extra low, low, medium, high, extra high, and/or the like.

In some examples, the emotions data 114 may represent the values using any technique. For a first example, and for the emotional state, the value may include a first token and/or tag for anger, a second token and/or tag for calm, a third token and/or tag for happy, a fourth token and/or tag for helpful, and/or so forth. For a second example, and again for the emotional state, the value may include a first value and/or string of characters (e.g., 1) for anger, a second value and/or string of characters (e.g., 2) for calm, a third value and/or string of characters (e.g., 3) for happy, a fourth value and/or string of characters (e.g., 4) for helpful, and/or so forth. For a third example, and again for the emotional state, each type of emotional state may be associated with one or more bytes associated with the emotions data. As such, the byte(s) that is associated with the determined emotional state may include one or more first values (e.g., 1) and the bytes associated with the other emotional states may include one or more second values (e.g., 0). Additionally, similar techniques may be used for the values associated with the intensity and/or the characteristics.

While the example of FIG. 1A illustrates the emotions data 114 as being separate from the text data 110, in some examples, the emotions data 114 may include at least a portion of the text data 110. For instance, the emotions component 112 may generate the emotions data 114 by adding the emotions information to the text data 110. For example, if the text data 110 represents a series of tokens associated with the text (e.g., the response by the character), then the emotions component 112 may generate the emotions data 114 by adding tags associated with the values of the emotional state and the variables to the text data. In such examples, the tags associated with a single emotional state may be associated with one or more of the tokens. For example, a first set of tags associated with a first determined emotional state may be associated with a first set of tokens, a second set of tags associated with a second determined emotional state may be associated with a second set of tokens, a third set of tags associated with a third determined emotional state may be associated with a third set of tokens and/or so forth.

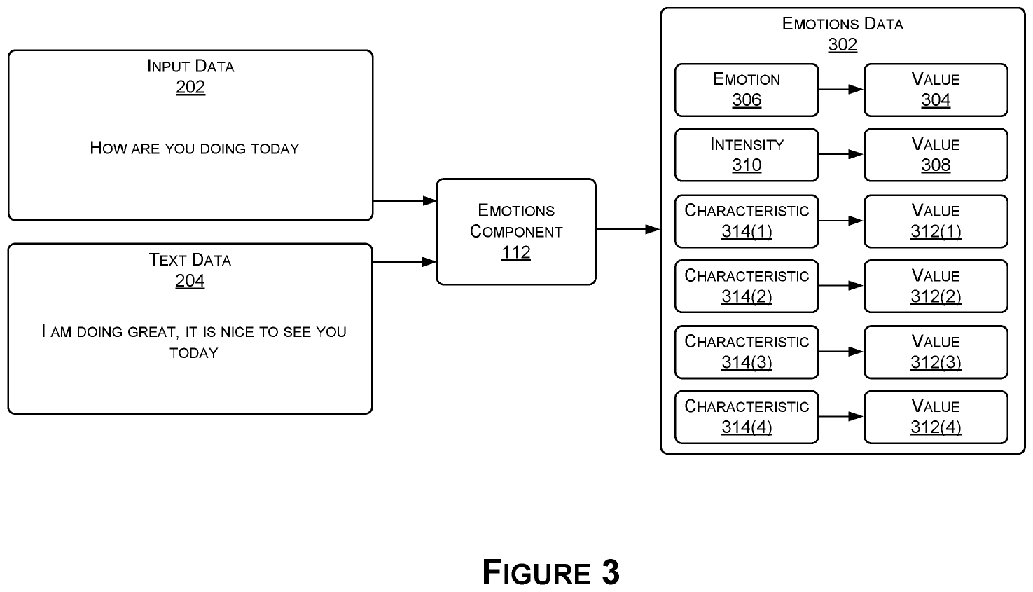

For instance, FIG. 3 illustrates an example of determining emotions information associated with speech that is output by a character, in accordance with some embodiments of the present disclosure. As shown by the example of FIG. 3, the emotions component 112 may receive the input data 202 and/or the text data 204. The emotions component 112 may then be configured to process the input data 202 and the text data 204 and, based at least on the processing, generate emotions data 302 (which may represent, and/or include, the emotions data 114) representing emotions information associated with the text. For instance, the emotions data 302 may represent a value 304 associated with an emotional state 306 and a value 308 associated with an intensity 310 of the emotional state 306. As described herein, the value 304 may indicate anger, calm, disgust, fearful, happy, helpful, humor, sad, and/or any other emotional state. Additionally, the value 308 may indicate very low, low, medium, high, very high, and/or any other intensity level associated with the emotional state.

The emotions data 302 further represents values 312(1)-(4) (also referred to singularly as “value 312” or in plural as “values 312”) for different characteristics 314(1)-(4) (also referred to singularly as “characteristic 314” or in plural as “characteristics 314”) of speech. For example, if the first characteristic 314(1) includes volume, than the first value 312(1) may indicate silent, extra low, low, medium, high, extra high, and/or the like. Additionally, if the second characteristic 314(2) includes pitch, then the second value 312(2) may indicate extra low, low, medium, high, extra high, and/or the like. Furthermore, if the third characteristic 314(3) includes rate, then the third value 312(3) may indicate extra low, low, medium, high, extra high, and/or the like. Moreover, if the fourth characteristic 314(4) indicates an emphasis on at least a portion of the text, then the fourth value 312(4) may indicate a first value (e.g., 0) if the at least the portion of the text should not be emphasized or a second value (e.g., 1) if the at least the portion of the text should be emphasized.

While the example of FIG. 3 illustrates the emotions data 302 as being separate from the text data 204, in other examples, the emotions data 302 may include at least a portion of the text data 204. For example, the emotions component 112 may generate the emotions data 302 by adding the emotions information to the text data 204. In such an example, the emotions data 302 may thus represent a series of tokens associated with the text from the text data 204 and tags associated with the emotions information. For instance, the emotions data 302 may represent one or more first tags that are associated with the value 304 of the emotional state 306, one or more second tags that are associated with the value 308 of the intensity 310, one or more third tags that are associated with the first value 31(1) of the first characteristic 314(1), one or more fourth tags that are associated with the second value 312(2) of the second characteristic 314(2), one or more fifth tags that are associated with the third value 3312(3) of the third characteristic 314(3), and/or one or more sixth tags that are associated with the fourth value 312(4) of the fourth characteristic 314(4).

As further illustrated in the example of FIG. 1A, in some examples, the input data 104 that is applied to the emotions component 112 may include prompt data 116 representing one or more prompts (e.g., one or more tokens) that are used to cause the emotions component 112 to generate specific types of emotions information. For a first example, if the emotions component 112 is to generate emotions data 114 that includes a specific value for the emotional state, such as a value associated with anger, then the prompt data 116 may represent one or more prompts (e.g., one or more tokens) that cause the emotions component 112 to generate that value for the emotional state. For a second example, if the emotions component 112 is to generate emotions data 114 that includes a specific value for the intensity of the emotional state, such as a value associated with medium, then the prompt data 116 may represent one or more prompts (e.g., one or more tokens) that cause the emotions component 112 to generate that value for the intensity. Still, for a third example, if the emotions component 112 is to generate emotions data 114 that includes a specific value for a characteristic of speech, such as a value associated with a medium rate, then the prompt data 116 may represent one or more prompts (e.g., one or more tokens) that cause the emotions component 112 to generate that value for the characteristic. In examples that use the prompt data 116, the prompt data 116 may be learned during the training of the emotions component 112.

Referring back to the example of FIG. 1A, the process 100 may include a speech component 118 receiving at least a portion of the text data 110 and/or at least a portion of the emotions data 114. The process 100 may then include the speech component 118 processing the at least the portion of the text data 110 and/or the at least the portion of the emotions data 114 and, based at least on the processing, generating audio data 120 representing speech. In some examples, the speech component 118 may include and/or use one or more machine learning models, one or more neural networks, one or more algorithms, one or more tables, and/or any other service, tool, and/or technique to perform one or more of the processes described herein with respect to the speech component 118. For example, the speech component 118 may include a text-to-speech (TTS) service and/or model.

As described herein, the speech represented by the audio data 120 may be associated with (e.g., include the words of) the text represented by the text data 110. Additionally, the speech may be expressed based at least on the emotions information represented by the emotions data 114. For example, the audio data 120 may cause the speech to be spoken using the emotional state and/or the intensity of the emotional state as represented by the emotions data 114. Additionally, the audio data 120 may cause the speech to be spoken using the values of the characteristics associated with speech, such as the volume level, the pitch level, the rate speed, an emphasis if needed, and/or the like as represented by the emotions data 114. In other words, the speech component 118 may be configured to generate the audio data such that the character outputs the speech in a way in which the emotion is expressed.

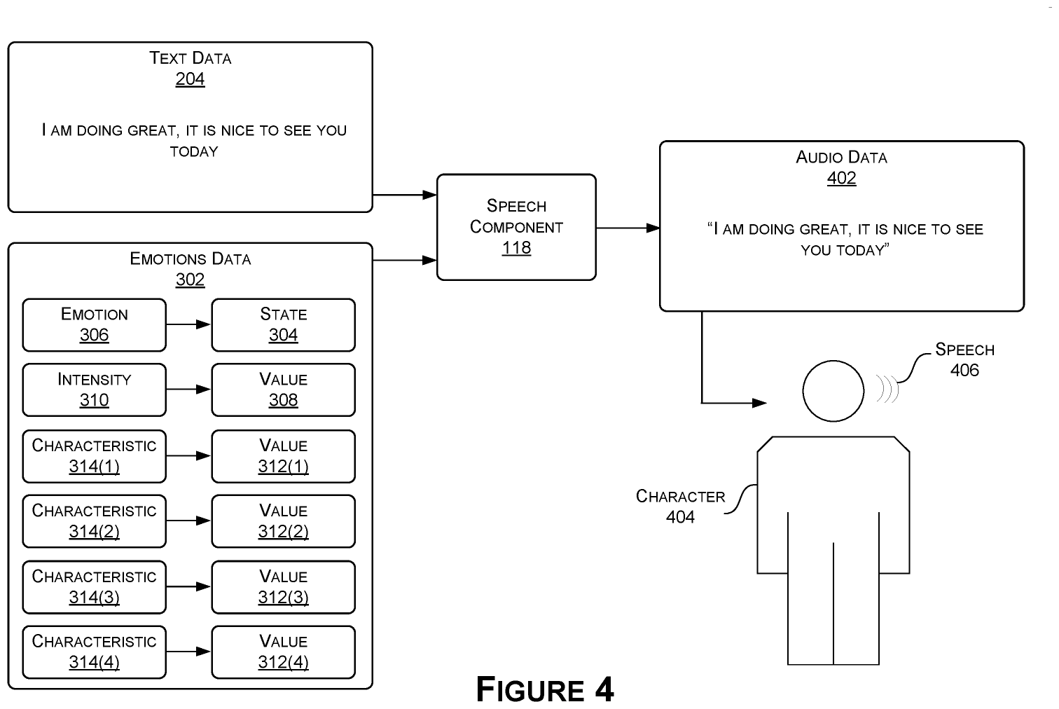

For instance, FIG. 4 illustrates an example of generating speech that expresses emotion, in accordance with some embodiments of the present disclosure. As shown by the example of FIG. 4, the speech component 118 may receive at least the text data 204 and the emotions data 302. The speech component 118 may then process the text data 204 and the emotions data 302 and, based at least on the processing, generate audio data 402 (which may represent, and/or include, the audio data 120) representing speech. As shown, the speech includes the text “I am doing great, it is nice to see you today.” The audio data 402 may then be used to cause a character 404 to output the speech, which may be represented by 406. For instance, the character 404 may output the speech in a way that emphasizes the intensity of the emotional state 304 and/or the characteristics 314 of the speech 406.

For example, the speech 406 output by the character 404 may be associated with the intensity level indicated by the value 308 of the intensity 310. Additionally, the volume of the speech 406 may be based on the volume level indicated by the first value 312(1), the pitch of the speech 406 may be based on the pitch level indicated by the second value 312(2), the rate of the speech 406 may be based on the rate speed indicated by the third value 312(3), and one or more portions of the speech may be emphasized based on the fourth value 312(4).

Referring back to the example of FIG. 1A, the process 100 may continue to repeat in order to generate additional audio data 120 representing additional speech for output by the character. For example, the process 100 may repeat in order to generate audio data 120 for each letter, symbol, number, punctuation mark, word, sentence, paragraph, and/or the like associated with the speech that is output by the character. This way, the emotional state of the character may continue to be updated as the character continues to communicate with the user(s) and/or the other character(s).

As described herein, in some examples, by performing the process 100 of FIG. 1A, audio data 120 may represent speech that is expressed using different emotional states even for text data 110 that represents the same text. For example, based at least on processing first input data 104, the text component 102 may generate first text data 110 representing text. The emotions component 112 may then process the first input data 104 and/or the first text data 110 and, based at least on the processing, generate first emotions data 114 representing first emotions information associated with the text. Additionally, based at least on processing second input data 104 that at least partially differs from the first input data 104, the text component 102 may generate second text data 110 representing the same text. However, the emotions component 112 may then process the second input data 104 and/or the second text data 110 and, based at least on the processing, generate second emotions data 114 representing second emotions information associated with the text. For example, the emotional state, the intensity of the emotional state, and/or one or more values for one or more variables may differ between the first emotions information and the second emotions information even though both are associated with the same text. As such, the process 100 may generate speech for a character that better expresses the actual emotional state based on the circumstances surrounding the communications.

While the example of FIG. 1A illustrates one example layout for a speech system, in order examples, the speech system may include a different layout. For instance, FIG. 1B illustrates a second example data flow diagram of a second process 122 of using one or more machine learning models to generate speech that expresses emotional states, in accordance with some embodiments of the present disclosure. As shown, the process 122 may include a processing component 124 receiving input data 126, where the input data 126 includes user data 128, character data 130, prompt data 132, and/or any other type of data. For instance, in some examples, the input data 126, the user data 128, the character data 130, and/or the prompt data 132 may respectively be similar to and/or include the user input data 104, the user data 106, the character data 108, and/or the prompt data 116.

The process 122 may then include the processing component 124 processing the input data 126 and, based at least on the processing, generating, and/or outputting data 134. In some examples, the processing component 124 may include and/or use one or more machine learning models (e.g., one or more large language models (LLMs)), one or more neural networks, one or more algorithms, one or more tables, and/or any other service, tool, and/or technique to perform one or more of the processes described herein with respect to the processing component 124 As shown, the processing component 124 may include at least a text component 136 (which may be similar to, and/or include, the text component 102) and an emotions component 138 (which may be similar to, and/or include, the emotions component 112).

For example, if the processing component 124 includes one or more machine learning models, then the text component 136 may include one or more layers and/or one or more channels of the machine learning model(s) that are trained to generate text data 140 and the emotions component 138 may include one or more layers and/or one or more channels of the machine learning model(s) that are trained to generate emotions data 142. In some examples, the text data 140 and/or the emotions data 142 may respectively be similar to and/or include the text data 110 and/or the emotions data 114. In other words, the processing component 124 may be trained to output the data 134 that includes both the text data 140 and the emotions data 142.

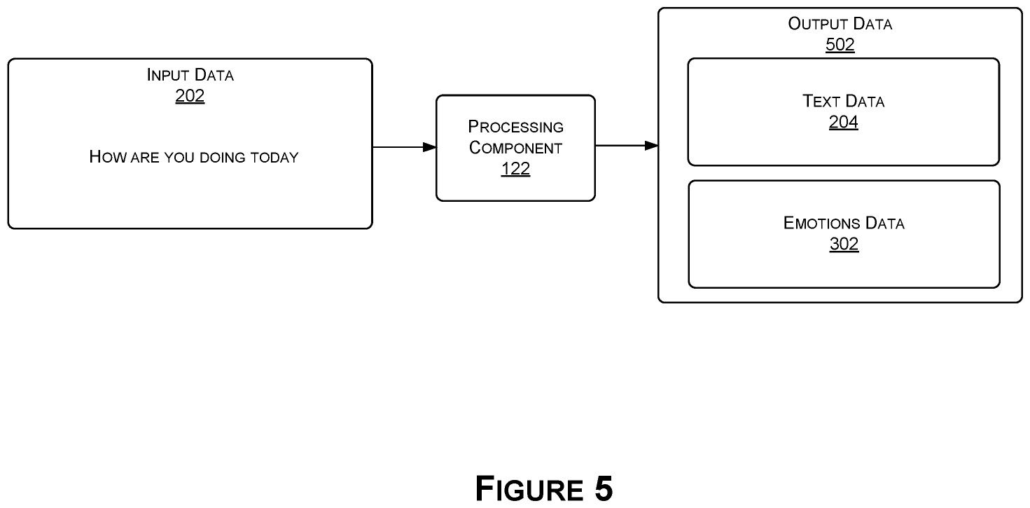

For instance, FIG. 5 illustrates an example of determining both text and emotions information associated with speech that is output by a character, in accordance with some embodiments of the present disclosure. As shown by the example of FIG. 5, the processing component 124 may receive the input data 202 (which may represent, and/or include, the input data 126). The processing component 124 may then process the input data 202 and, based at least on the processing, generate output data 502 (which may represent, and/or include, the output data 134) that includes both the text data 204 (which may represent, and/or include, the text data 140) and the emotions data 302 (which may represent, and/or include, the emotions data 142).

Referring back to the example of FIG. 1B, the process 1240 may include the speech component 118 receiving at least a portion of the output data 134. The process 122 may then include the speech component 118 processing the at least the portion of the output data 134 and, based at least on the processing, generating audio data 144 representing speech. In some examples, the audio data 144 may represent and/or include the audio data 120.

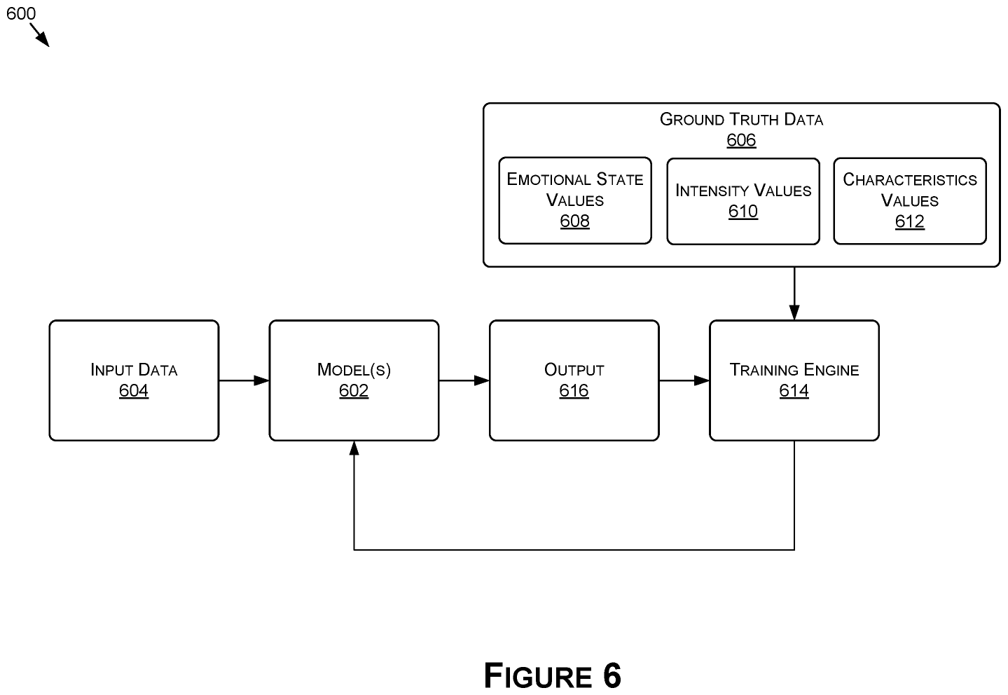

FIG. 6 illustrates a data flow diagram illustrating a process 600 for training one or more models 602 to generate emotion information associated with speech, in accordance with some embodiments of the present disclosure. In some examples, the model(s) 602 may include and/or be used by the emotions component 112 and/or the processing component 124 (e.g., the emotions component 142). As shown, the model(s) 602 may be rained using input data 604. In some examples, the input data 604 may be similar to the input data 104 and/or the input data 126. For example, the input data 604 may include user data associated with one or more users and/or character data associated with one or more characters. In some examples, such as examples where the model(s) 602 is separate from the text component 102 as illustrated in the example of FIG. 1A, the input data 604 may further include text data represent text. For example, the input data 126 may represent the text data 110 generated using the text component 102.

The model(s) 602 may be trained using the training input data 604 as well as corresponding ground truth data 606. The ground truth data 606 may include annotations, labels, masks, and/or the like. For instance, and as shown, the ground truth data 606 may represent values associated with different emotions and/or speech, such as emotional state values 608 indicating different emotional states that the model(s) 602 is trained to detect, intensity values 610 indicating different intensity levels that the model(s) 602 is trained to detect, and/or characteristics values 612 indicating different speech characteristic levels that the model(s) 602 is trained to detect. The ground truth data 606 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the input data 604, there may be corresponding ground truth data 606.

As further illustrated in FIG. 6, a training engine 614 may use one or more loss functions that measure loss (e.g., error) in outputs 616 as compared to the ground truth data 606. In some examples, the outputs 616 may be similar to the emotions data 114 and/or the emotions data 142. For instance, the outputs 616 may indicate values for emotional states, values for intensities, and/or values for speech characteristics. Any type of loss function may be used, such as cross entropy loss, mean squared error, mean absolute error, mean bias error, and/or other loss function types. In some examples, different outputs 616 may have different loss functions. For example, the emotional state values may have a first loss function, the intensity values may have a second loss function, and/or one or more of the characteristics values (e.g., values associated with each type of characteristic) may have a respective third loss function. In such examples, the loss functions may be combined to form a total loss, and the total loss may be used to train (e.g., update the parameters of) the model(s) 602. In any example, backward pass computations may be performed to recursively compute gradients of the loss function(s) with respect to training parameters. In some examples, weights and biases of the model(s) 602 may be used to compute these gradients.

In some examples, one or more additional techniques may be used to train the model(s) 602, such as to increase the efficiency of the training. For instance, the model(s) 602 may be trained to determine different variables at different instances of training. For example, during first instance of training, the model(s) 602 may be trained in order to determine values associated with the emotional states of speech. Additionally, during a second instance of training, the model(s) 602 may be trained in order to determine values associated with the intensities of the emotional states. Furthermore, during a third instance of training, the model(s) 602 may be trained in order to determine values for a first characteristic of speech. This technique may then continue to in order to train the model(s) to determine values for one or more other variables associated with determining emotions information.

Additionally, one or more techniques (e.g., p-tuning, prompt-tuning, LoRA, prompt engineering, etc.) may be used to determine one or more prompts associated with causing the model(s) 602 to generate specific emotions information, where the prompts may be represented by the prompt data 116 and/or the prompt data 132. For example, the training may include determining one or more prompts that cause the model(s) 602 to determine one or more values for one or more specific emotional states, one or more prompts that cause the model(s) 602 to determine one or more values for one or more intensity levels, and/or one or more prompts that cause the model(s) 602 to determine one or more values for one or more characteristic levels associated with speech. In some examples, the process of determining the prompts may be in addition to, or alternatively from, the process of updating the model(s) 602 (e.g., updating the parameters of the model(s) 602) during training.

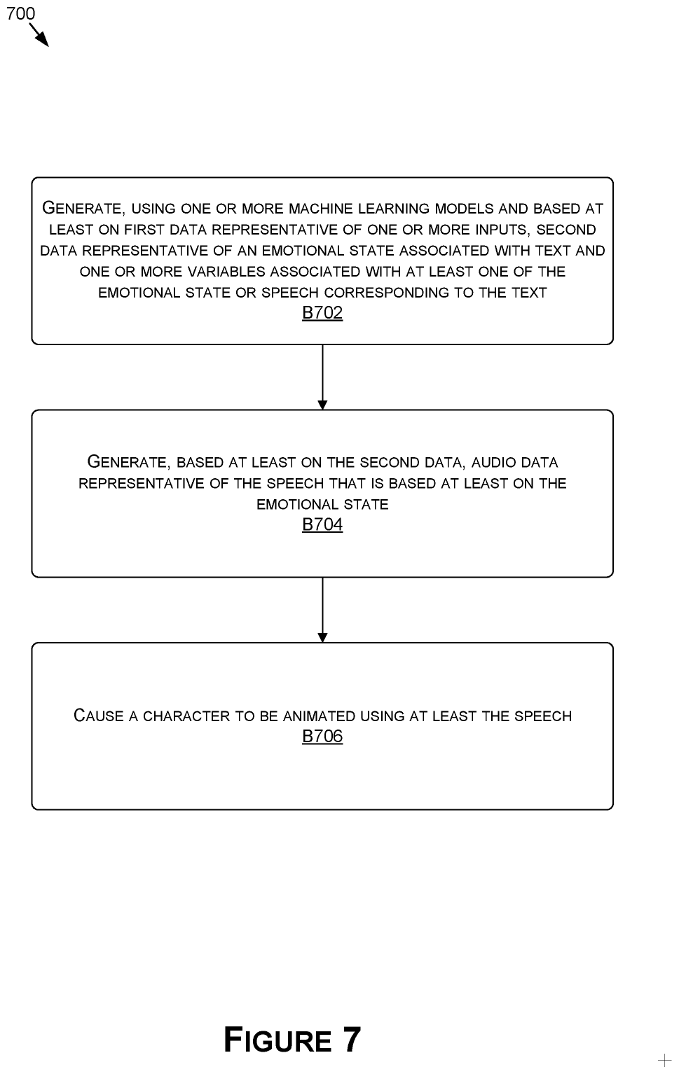

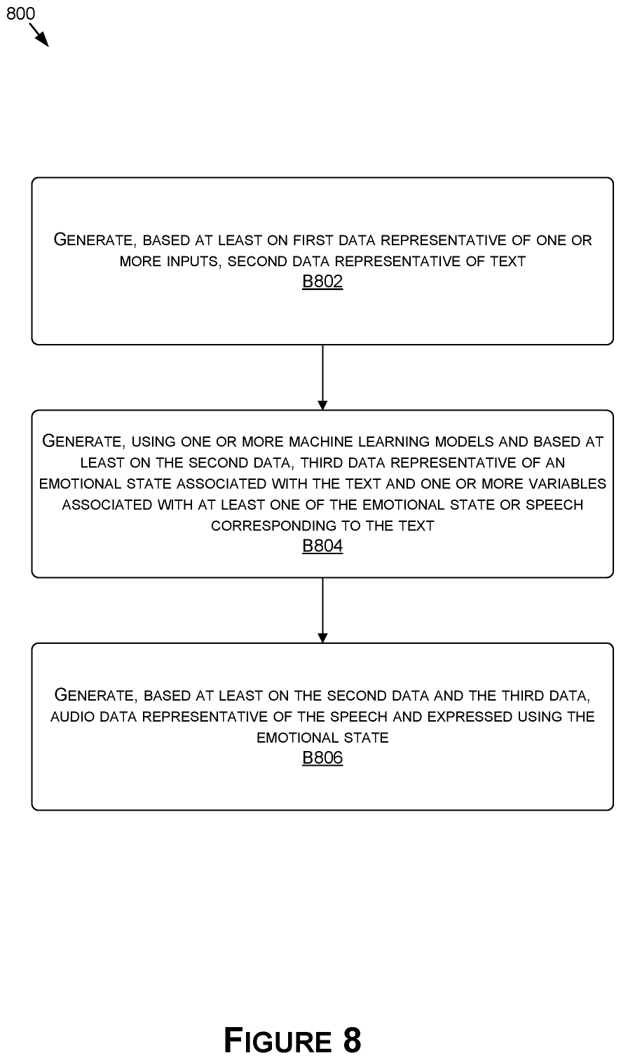

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The method 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, methods 700 and 800 are described, by way of example, with respect to FIGS. 1A-1B. However, these methods 700 and 800 may additionally or alternatively be executed by any one system, or any combination of systems, including, but not limited to, those described herein.

FIG. 7 illustrates a flow diagram showing a method 700 for causing a character to communicate using speech that expresses emotion, in accordance with some embodiments of the present disclosure. The method 700, at block B702, may include generating, using one or more machine learning models and based at least on first data representative of one or more inputs, second data representative of an emotional state associated with text and one or more variables associated with at least one of the emotional state or speech corresponding to the text. For instance, the emotions component 112 (e.g., the machine learning model(s)) may process the input data 104 and/or the text data 110 (e.g., the first data). Based at least on the processing, the emotions component 112 may generate the emotions data 114 (e.g., the second data) representing the emotional state and the variable(s). As described herein, the emotions data 114 may represent at least a value for the emotional state and at least a respective value for one or more (e.g., each) of the variable(s).

While this example described the emotions component 112 processing the input data 104 and/or the text data 110 in order to generate the emotions data 114, in other examples, the processing component 124 (e.g., the machine learning model(s)) may process the input data 126 (e.g., the first data) in order to generate the output data 134 (e.g., the second data). As described herein, the output data 134 may include the text data 140 and the emotions data 142.

The method 700, at block B704, may include generating, based at least on the second data, audio data representative of speech and based at least on the emotional state. For instance, the speech component 118 may process the emotions data 114 and/or the text data 110 (and/or the output data 134). Based at least on the processing, the speech component 118 may generate the audio data 120 (and/or the audio data 144) that represents the speech that is expressed using the emotional state. For example, the audio data 120 may cause the speech to be spoken using the emotional state and/or the intensity of the emotional state as represented by the emotions data 114. Additionally, the audio data 120 may cause the speech to be spoken using the values of the characteristics associated with the speech, such as the volume level, the pitch level, the rate speed, an emphasis if needed, and/or the like as represented by the emotions data 114.

The method 700, at block B706, may include causing a character to be animated using at least the speech. For instance, the audio data 120 may be used to animate a character, where the animation includes the character outputting the speech in a way that expresses the emotional state.

FIG. 8 illustrates a flow diagram showing a method 800 for generating audio data representing speech that expresses emotion, in accordance with some embodiments of the present disclosure. The method 800, at block B802, may include generating, using first data representative of one or more inputs, second data representative of text. For instance, the text component 102 may receive the input data 104 (e.g., the first data) that represents the one or more inputs. As described herein, the input data 104 may include the user data 106 and/or the character data 108. The text component 102 may then process the input data 104 and, based at least on the processing, generate the text data 110 (e.g., the second data) representing the text.

The method 800, at block B804, may include generating, using one or more machine learning models and based at least on the second data, third data representative of an emotional state associated with the text and one or more variables associated with at least one of the emotional state or speech corresponding to the text. For instance, the emotions component 112 (e.g., the machine learning model(s)) may process the text data 110. In some examples, the emotions component 112 may further process the input data 104. Based at least on the processing, the emotions component 112 may generate the emotions data 114 (e.g., the third data) representing the emotional state and the variable(s). As described herein, the emotions data 114 may represent at least a value for the emotional state and at least a respective value for one or more (e.g., each) of the variable(s).

The method 800, at block B806, may include generating, based at least on the second data and the third data, audio data representative of speech and expressed using the emotional state. For instance, the speech component 118 may process the emotions data 114 and/or the text data 110. Based at least on the processing, the speech component 118 may generate the audio data 120 that represents the speech that is expressed using the emotional state. For example, the audio data 120 may cause the speech to be spoken using the emotional state and/or the intensity of the emotional state as represented by the emotions data 114. Additionally, the audio data 120 may cause the speech to be spoken using the values of the characteristics associated with speech, such as the volume level, the pitch level, the rate speed, an emphasis if needed, and/or the like as represented by the emotions data 114.

### Example Computing Device

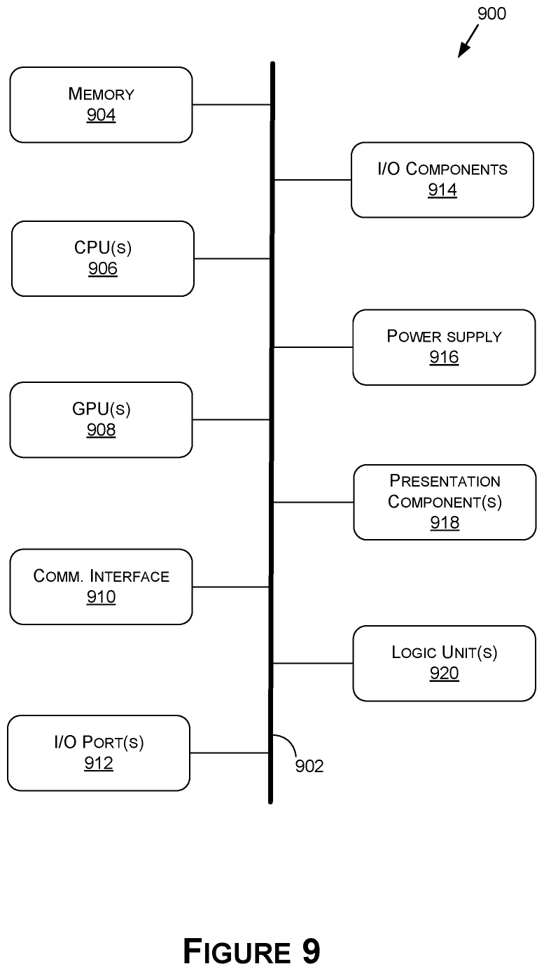

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

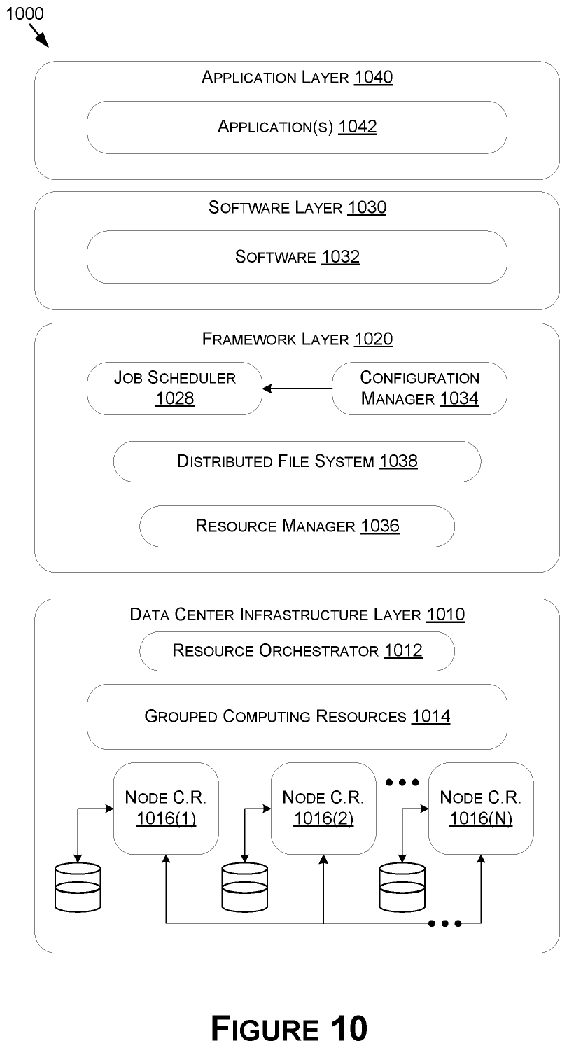

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, using one or more language models and based at least on first data representative of one or more inputs, second data representative of an emotional state associated with text and one or more variables associated with at least one of the emotional state or speech associated with the text; generating, based at least on the second data, audio data representative of the speech that is based at least on the emotional state and the one or more variables; and causing a character to be animated using at least the speech.

B: The method of paragraph A, further comprising at least one of: generating, using the one or more language models and based at least on the first data, third data representative of the text; or generating, using one or more second language models, the third data representative of the text.

C: The method of paragraph A or paragraph B, wherein: the one or more variables include at least an intensity associated with the emotional state; and the second data further represents a value associated with the intensity.

D: The method of any one of paragraphs A-C, wherein: the one or more variables include one or more characteristics associated with the speech, the one or more characteristics including at least one of a volume, a rate, a pitch, or an emphasis associated with the speech; and the second data further represents one or more values associated with the one or more characteristics.

E: The method of any one of paragraphs A-D, wherein: the one or more variables include at least an intensity level associated with the emotional state and one or more characteristics associated with the speech; the second data further represents a first value associated with the intensity level and one or more second values associated with one or more levels of the one or more characteristics; and the generating the audio data representative of the speech comprises generating, based at least on the emotional state, the first value, and the one or more second values, the audio data such that the speech expresses the emotional state using the intensity level and the one or more characteristic levels.

F: The method of any one of paragraphs A-E, wherein the first data includes at least one of: first input data associated with a user, the first input data including at least one of text data representative of inputted text, second audio data representative of user speech, or image data representative of one or more images corresponding to the user; or second input data associated with the character, the second data representative of at least one of one or more characteristics associated with the character, one or more situations associated with the character, or one or more interactions associated with the character, or one or more past communications associated with the character.

G: The method of any one of paragraphs A-F, wherein: the first data further represents one or more first values associated with the one or more variables; and the method further comprises generating, using the one or more language models and based at least on third data representative of one or more second inputs, fourth data representative of a second emotional state associated with the text and one or more second values associated with the one or more variables.

H: The method of any one of paragraphs A-G, wherein: the second data is associated with a first portion of the text and further represents one or more first values for the one or more variables; and the method further comprises: generating, using the one or more language models and based at least on the first data, third data associated with a second portion of the text, the third data representative of a second emotional state and one or more second values associated with the one or more variables; generating, based at least on the third data, second audio data representative of second speech associated with the second portion of the text, the second speech being based at least on the second emotional state and the one or more second values associated with the one or more variables; and causing the character to be animated using at least the second speech.

I: The method of any one of paragraphs A-H, wherein: the text includes one or more words; and the speech includes the one or more words spoken using the emotional state and based at least on the one or more variables.

J: A system comprising: one or more processing units to: generate, based at least on input data, first data representative of text; generate, using one or more language models and based at least on the first data, second data representative of an emotional state associated with the text and one or more variables associated with at least one of the emotion state or speech associated with the text; and generate, based at least on the first data and the second data, audio data representative of the speech that is based at least on the emotional state.

K: The system of paragraph J, wherein at least one of: the generation of the text data uses the one or more language models; or the generation of the text data uses one or more second language models.

L: The system of paragraph J or paragraph K, wherein: the one or more variables include at least an intensity associated with the emotional state; and the second data further represents a value associated with the intensity.

M: The system of any one of paragraphs J-L, wherein: the one or more variables include one or more characteristics associated with the speech, the one or more characteristics including at least one of a volume, a rate, a pitch, or an emphasis associated with the speech; and the second data further represents one or more values associated with the one or more characteristics.

N: The system of any one of paragraphs J-M, wherein: the one or more variables include at least an intensity associated with the emotional state and one or more characteristics associated with the speech; the second data further represents a first value associated with an intensity level of the intensity and one or more second values associated with the one or more characteristic levels of the one or more characteristics; and the generation of the audio data representative of the speech comprises generating, based at least on the emotional state, the first value, and the one or more second values, the audio data such that the speech expresses the emotional state using the intensity level and the one or more characteristic levels.

O: The system of any one of paragraphs J-N, wherein the one or more processing units are further to: obtain the input data associated with a user, the input data including at least one of second text data representative of inputted, second audio data representative of user speech, or image data representative of one or more images corresponding to the user, wherein the second data is further generated based at least on the input data.

P: The system of any one of paragraphs J-O, wherein the one or more processing units are further to: obtain the input data associated with a character that outputs the speech, the input data representative of at least one of one of one or more characteristics associated with the character, one or more situations associated with the character, or one or more interactions associated with the character, or one or more past communications associated with the character, wherein the second data is further generated based at least on the input data.

Q: The system of any one of paragraphs J-P, wherein the one or more processing units are further to causing a character to be animated based at least on the speech.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: A processor comprising: one or more processing units to generate audio data representative of speech expressed using an emotional state, where the audio data is generated based at least on data representative of the emotional state and one or more values associated with one or more variables associated with at least one of the emotional state or the speech, the data representative of the emotional state and the one or values being determined using one or more large language models (LLMs).

T: The processor of paragraph S, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, using one or more language models and based at least on first data representative of one or more inputs, second data representative of an emotional state associated with text and one or more variables associated with at least one of the emotional state or speech associated with the text;
generating, based at least on the second data, audio data representative of the speech that is based at least on the emotional state and the one or more variables; and
causing a character to be animated using at least the speech.

2. The method of claim 1, further comprising at least one of:
generating, using the one or more language models and based at least on the first data, third data representative of the text; or
generating, using one or more second language models, the third data representative of the text.

3. The method of claim 1, wherein:
the one or more variables include at least an intensity associated with the emotional state; and
the second data further represents a value associated with the intensity.

4. The method of claim 1, wherein:
the one or more variables include one or more characteristics associated with the speech, the one or more characteristics including at least one of a volume, a rate, a pitch, or an emphasis associated with the speech; and
the second data further represents one or more values associated with the one or more characteristics.

5. The method of claim 1, wherein:
the one or more variables include at least an intensity level associated with the emotional state and one or more characteristics associated with the speech;
the second data further represents a first value associated with the intensity level and one or more second values associated with one or more levels of the one or more characteristics; and
the generating the audio data representative of the speech comprises generating, based at least on the emotional state, the first value, and the one or more second values, the audio data such that the speech expresses the emotional state using the intensity level and the one or more characteristic levels.

6. The method of claim 1, wherein the first data includes at least one of:
first input data associated with a user, the first input data including at least one of text data representative of inputted text, second audio data representative of user speech, or image data representative of one or more images corresponding to the user; or
second input data associated with the character, the second data representative of at least one of one or more characteristics associated with the character, one or more situations associated with the character, or one or more interactions associated with the character, or one or more past communications associated with the character.

7. The method of claim 1, wherein:
the first data further represents one or more first values associated with the one or more variables; and
the method further comprises generating, using the one or more language models and based at least on third data representative of one or more second inputs, fourth data representative of a second emotional state associated with the text and one or more second values associated with the one or more variables.

8. The method of claim 1, wherein:
the second data is associated with a first portion of the text and further represents one or more first values for the one or more variables; and
the method further comprises:
generating, using the one or more language models and based at least on the first data, third data associated with a second portion of the text, the third data representative of a second emotional state and one or more second values associated with the one or more variables;
generating, based at least on the third data, second audio data representative of second speech associated with the second portion of the text, the second speech being based at least on the second emotional state and the one or more second values associated with the one or more variables; and
causing the character to be animated using at least the second speech.

9. The method of claim 1, wherein:
the text includes one or more words; and
the speech includes the one or more words spoken using the emotional state and based at least on the one or more variables.

10. A system comprising:
one or more processing units to:
generate, based at least on input data, first data representative of text;
generate, using one or more language models and based at least on the first data, second data representative of an emotional state associated with the text and one or more variables associated with at least one of the emotion state or speech associated with the text; and
generate, based at least on the first data and the second data, audio data representative of the speech that is based at least on the emotional state.

11. The system of claim 10, wherein at least one of:
the generation of the text data uses the one or more language models; or
the generation of the text data uses one or more second language models.

12. The system of claim 10, wherein:
the one or more variables include at least an intensity associated with the emotional state; and
the second data further represents a value associated with the intensity.

13. The system of claim 10, wherein:
the one or more variables include one or more characteristics associated with the speech, the one or more characteristics including at least one of a volume, a rate, a pitch, or an emphasis associated with the speech; and
the second data further represents one or more values associated with the one or more characteristics.

14. The system of claim 10, wherein:
the one or more variables include at least an intensity associated with the emotional state and one or more characteristics associated with the speech;
the second data further represents a first value associated with an intensity level of the intensity and one or more second values associated with the one or more characteristic levels of the one or more characteristics; and
the generation of the audio data representative of the speech comprises generating, based at least on the emotional state, the first value, and the one or more second values, the audio data such that the speech expresses the emotional state using the intensity level and the one or more characteristic levels.

15. The system of claim 10, wherein the one or more processing units are further to:
obtain the input data associated with a user, the input data including at least one of second text data representative of inputted, second audio data representative of user speech, or image data representative of one or more images corresponding to the user,
wherein the second data is further generated based at least on the input data.

16. The system of claim 10, wherein the one or more processing units are further to:
obtain the input data associated with a character that outputs the speech, the input data representative of at least one of one of one or more characteristics associated with the character, one or more situations associated with the character, or one or more interactions associated with the character, or one or more past communications associated with the character,
wherein the second data is further generated based at least on the input data.

17. The system of claim 10, wherein the one or more processing units are further to causing a character to be animated based at least on the speech.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. A processor comprising:
one or more processing units to generate audio data representative of speech expressed using an emotional state, where the audio data is generated based at least on data representative of the emotional state and one or more values associated with one or more variables associated with at least one of the emotional state or the speech, the data representative of the emotional state and the one or values being determined using one or more large language models (LLMs).

20. The processor of claim 19, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
